(19) United States
(12) Patent Application Publication
(10) Pub. No.: US 2024/0175990 A1
(43) Pub. Date: May 30, 2024

(54) LIDAR

(71) Applicant: SUTENG INNOVATION TECHNOLOGY CO., LTD., Shenzhen (CN)

(72) Inventor: Huazhou CHEN, Shenzhen (CN)

(73) Assignee: SUTENG INNOVATION TECHNOLOGY CO., LTD., Shenzhen (CN)

(21) Appl. No.: 18/515,232

(22) Filed: Nov. 20, 2023

(30) Foreign Application Priority Data
Nov. 24, 2022 (CN) 202211483189.5

(51) Int. Cl. G01S 7/481

(52) U.S. Cl. CPC G01S 7/4817; G01S 7/4814; G01S 7/4816

(57) ABSTRACT

A LIDAR includes an emission module, a beam adjustment module and a receiving module, where the beam adjustment module includes a first scanning apparatus and a second scanning apparatus. The emission module is configured to emit a laser beam. The first scanning apparatus is rotated in a first set direction to drive the laser beam to scan along a first direction, and the second scanning apparatus is rotated in a second set direction to drive the laser beam to scan along a second direction. A receiving beam is formed after the laser beam is reflected in the detection region, and the receiving beam is reflected by the second mirror of the second scanning apparatus and then received by the receiving module. The size of the first scanning apparatus can be reduced.

### CROSS-REFERENCE TO RELATED APPLICATION

The present application claims the benefit of priority to Chinese Patent Application No. 202211483189.5, filed on Nov. 24, 2022, which is hereby incorporated by reference in its entirety.

### TECHNICAL FIELD

This application pertains to the field of Light Detection and Ranging (LiDAR) detection, and in particular, relates to a LiDAR.

### TECHNICAL BACKGROUND

In the field of autonomous driving, increasing dot frequency for emitting a laser beam by a LiDAR can improve detection accuracy of the LiDAR, and therefore, increasing the dot frequency can help improve safety of the autonomous driving. How to increase the dot frequency has become a major research subject in the field of LiDAR.

In the past, a mechanical multi-line LiDAR was used for detection. Emission devices and receiving devices are usually stacked to improve a wiring harness for the mechanical multi-line LiDAR, and the mechanical multi-line LiDAR is also rotated to drive a platform mechanism to drive the emission devices and the receiving devices, thereby meeting a detection need. However, the stacking of the emission devices and the receiving devices causes complex system and circuit designs for the LiDAR, and rotating the LiDAR to drive the platform mechanism further increases a volume of the LiDAR, making it difficult for the LiDAR to adapt to mounting space on a vehicle.

### SUMMARY

An embodiment of this application provides a LiDAR, including: an emission module, a beam adjustment module and a receiving module, where the beam adjustment module includes a first scanning apparatus and a second scanning apparatus, and the second scanning apparatus includes a first mirror and a second mirror; the emission module includes at least one emission device, the emission device is configured to emit a laser beam, the laser beam is sequentially reflected by the first scanning apparatus and the first mirror and then directed toward a detection region, the first scanning apparatus is rotated in a first set direction to drive the laser beam to scan along a first direction, and the second scanning apparatus is rotated in a second set direction to drive the laser beam to scan along a second direction; and a receiving beam is formed after the laser beam is reflected in the detection region, and the receiving beam is reflected by the second mirror and then received by the receiving module.

In an embodiment, the laser beam forms multiple scanning lines arranged along the first direction in the detection region, the receiving module includes at least two receiving devices, receiving beams corresponding to at least two of the multiple scanning lines are received by the same receiving device, and scanning lines emitted simultaneously in the multiple scanning lines are received by different receiving devices.

In an embodiment, at least two receiving devices are arranged into multiple columns, and receiving devices in two adjacent columns are staggered, so that main optical axes for receiving echo beams by any adjacent receiving devices are staggered from each other.

In an embodiment, in an edge region of the detection region, receiving beams corresponding to the first number of scanning lines are received by the same receiving device, and in a central region of the detection region, receiving beams corresponding to the second number of scanning lines are received by the same receiving device, and the second number is greater than the first number.

In an embodiment, the first mirror and the second mirror are adjacent, an included angle between the first mirror and the second mirror is twice a first angle and twice a second angle, the first angle is an included angle between a laser beam emitted to the first mirror and the first mirror, and the second angle is an included angle between a receiving beam emitted from the second mirror and the second mirror.

In an embodiment, the second scanning apparatus is a rotating mirror.

In an embodiment, the emission module includes multiple emission devices, the multiple emission devices are divided into multiple groups, the same group of emission devices simultaneously emit laser beams, and different groups of emission devices emit laser beams at intervals.

In an embodiment, spacing between emission channels of two adjacent emission devices in the same group of emission devices is greater than preset spacing.

In an embodiment, a diameter of a light spot formed by the laser beam within a first preset distance is greater than preset length.

In an embodiment, a time interval between two adjacent emissions of laser beams performed by the emission module is greater than preset duration.

The laser beam emitted by the emission module is reflected by the first scanning apparatus and the first mirror of the second scanning apparatus and then directed to the detection region, and the receiving beam formed after the laser beam is reflected in the detection region is reflected by the second mirror of the second scanning apparatus and then received by the receiving module. That is, the first scanning apparatus is used at the emission end in the LiDAR to scan to increase outgoing laser beams in the first direction, a receiving end and the emission end are also configured to share a second scanning apparatus to scan, and the receiving end does not use the first scanning apparatus, which can reduce a size of the first scanning apparatus and further reduce the overall size of the device, thereby improving control flexibility of the first scanning apparatus. In addition, the first scanning apparatus is not used at the receiving end, so that a scanning surface of the first scanning apparatus imposes no limitation on a receiving aperture of the LiDAR. Therefore, the size of the first scanning apparatus is reduced, and the receiving aperture of the LiDAR is not affected, thereby improving detection performance.

### BRIEF DESCRIPTION OF DRAWINGS

In order to describe technical solutions in embodiments of this application more clearly, the following briefly describes drawings required for description of the embodiments.

FIG. 1 is a schematic diagram of a LiDAR according to an embodiment of this application;

FIG. 2 is a schematic diagram of scanning lines formed by multiple groups of detection laser beams according to an embodiment of this application;

FIG. 3 is a schematic diagram of scanning lines with a nonuniform density in a scanning field of view according to an embodiment of this application;

FIG. 4a to FIG. 4c are schematic diagrams of an arrangement manner of emission devices according to an embodiment of this application;

FIG. 5 is a schematic diagram of an angular relationship between a rotating mirror and the laser beam according to an embodiment of this application;

FIG. 6 is a schematic diagram of a relationship between changes in a rotation angle of a rotating mirror and a deflection angle of an echo beam according to an embodiment of this application; and

FIG. 7 is a schematic diagram of an arrangement manner of a receiving device according to an embodiment of this application.

### DETAILED DESCRIPTION

For purpose of illustration rather than limitation, the following describes details such as a system structure and technology, to facilitate a thorough understanding of the embodiments of this application. In other cases, detailed descriptions of well-known systems, apparatuses, circuits, and methods are omitted for purpose of brevity while not preventing a person of skilled in the art from carrying out the embodiments contained herein.

When used in this specification and appended claims, a term “include” indicates existence of a described feature, integrity, a step, an operation, an element and/or a component, but does not exclude existence or addition of one or more other features, integrity, steps, operations, elements, components and/or a collection thereof.

The term “and/or” used in this specification and appended claims of this application refers to any combination of one or more of the associated items listed and all possible combinations thereof, and inclusion of these combinations. In addition, in the description of the present application, the terms such as “first” and “second” are merely intended for purpose of description, and shall not be understood as an indication or implication of relative importance.

For a LiDAR that scans a detection region, to increase a frame rate of emitting a laser beam, a size of a scanning apparatus needs to be increased correspondingly. However, increasing the size of the scanning apparatus limits a movement speed and movement flexibility of the scanning apparatus, thereby limiting improvement of the frame rate.

In some embodiments, a LiDAR, where a first scanning apparatus and a second scanning apparatus are used at the emission end to scan. The emission end and a receiving end share a second scanning apparatus, and the receiving end uses the second scanning apparatus for scanning, which can reduce the size of the first scanning apparatus, thereby facilitating improvement of the movement speed and the movement flexibility of the scanning apparatus.

The LiDAR provided in this application is exemplarily described below.

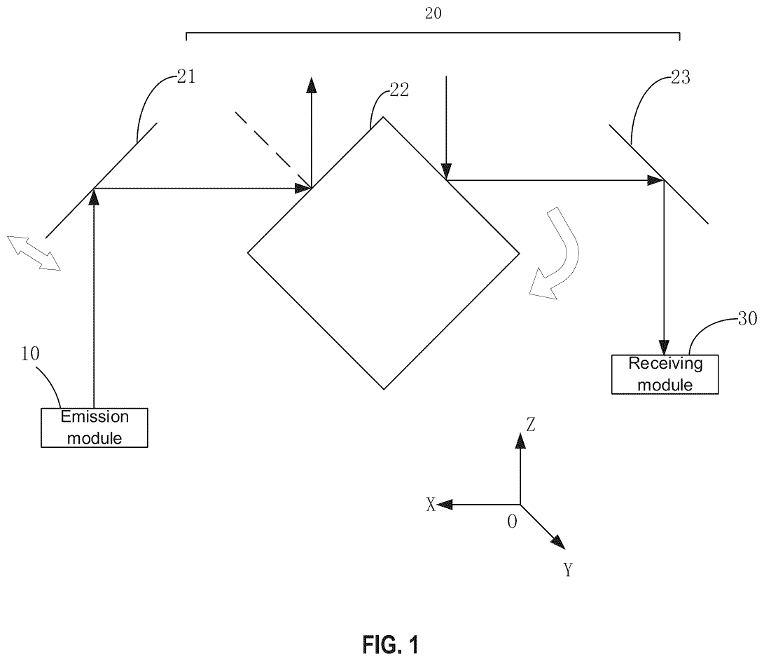

Referring to FIG. 1, the LiDAR provided in this embodiment of this application includes: an emission module 10, a beam adjustment module 20, and a receiving module 30, where the beam adjustment module 20 includes a first scanning apparatus 21 and a second scanning apparatus 22. The second scanning apparatus 22 includes a first mirror and a second mirror. The emission module 10 includes at least one emission device. The emission device is configured to emit a laser beam. The laser beam is sequentially reflected by the first scanning apparatus 21 and the first mirror of the second scanning apparatus 22 and then directed toward a detection region. The first scanning apparatus 21 is rotated in a first set direction to drive the laser beam to scan along a first direction, and the second scanning apparatus 22 is rotated in a second set direction to drive the laser beam to scan along a second direction. An echo beam is formed after the laser beam is reflected in the detection region, and the echo beam is reflected by the second mirror of the second scanning apparatus and then received by the receiving module. The receiving module includes at least two receiving devices arranged into an array.

Using the LiDAR system design shown in FIG. 1, the first scanning apparatus is used at the emission end in the LiDAR to scan to increase outgoing laser beams in the first direction. A receiving end and the emission end are also configured to share a second scanning apparatus to scan, and the receiving end does not use the first scanning apparatus, which can reduce a size of the first scanning apparatus 21 and further reduce the overall size of the device, thereby improving control flexibility of the first scanning apparatus 21. In addition, the first scanning apparatus 21 is not used at the receiving end, so that a scanning surface of the first scanning apparatus 21 imposes no limitation on a receiving aperture of the LiDAR. Therefore, even if the size of the first scanning apparatus 21 is reduced, the receiving aperture of the LiDAR is not affected, thereby improving detection performance.

The first scanning apparatus 21 may be any device among a rotating mirror, a galvanometer, and a rotating platform. The second scanning apparatus 22 may be the rotating mirror, and the rotating mirror may be a polygonal prism such as a triangular prism, a quad prism, a pentaprism, a hexagonal prism, or an octagonal prism. The number of surfaces of the rotating mirror is not specifically limited in this application. The polygonal prism can be a regular prism, and the regular prism is a prism whose surfaces all correspond to equal central angles. The first mirror and the second mirror of the second scanning apparatus 22 are adjacent mirrors. A type of the first scanning apparatus is not limited in this application. Types of the first scanning apparatus and the second scanning apparatus may be the same or different. In an embodiment, the scanning apparatuses in the two dimensions can be individually controlled. A scanning manner of the first scanning apparatus and a scanning direction controlled by the second scanning apparatus are not exclusively limited in this application. In an embodiment of this application, the first scanning apparatus controls scanning in a vertical direction, and the second scanning apparatus controls scanning in a horizontal direction.

The emission module 10 may include at least one emission device. The emission module 10 may include one or more groups of emission devices. The emission device may be a vertical-cavity surface-emitting Laser (VCSEL) or an edge emitting laser (EEL), or a fiber laser emits light, and an outgoing array is formed in a light splitting method. Each group of emission devices may include one or more emission devices. For example, each group of emission devices may include one, two, three, four, or five emission devices. When one group of emission devices include multiple emission devices, the multiple emission devices may be arranged in one or two columns. An arrangement manner of each group of emission devices is not limited in this application. In an embodiment, physical intervals between the lasers in the multiple emission groups in a transverse direction and a longitudinal direction may be equal or unequal.

After the laser beam emitted by the emission module 10 passes through the first scanning apparatus 21 and the second scanning apparatus 22, multiple scanning lines are formed in the detection region. When the emission module 10 includes one group of emission devices, multiple scanning lines can be scanning lines formed after multiple emissions of the group of emission devices at preset time intervals. In an embodiment, when the emission module 10 includes multiple groups of emission devices, the multiple scanning lines may also be scanning lines formed after emissions of the multiple groups of emission devices at different times.

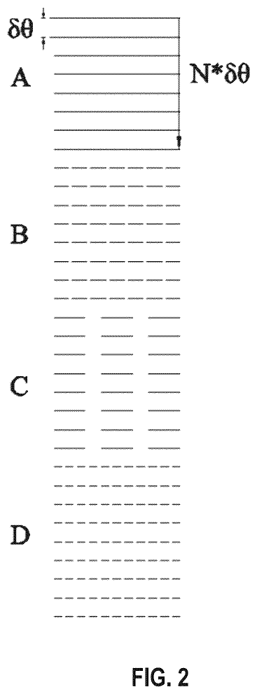

In an embodiment, as shown in FIG. 2, the emission module can output two adjacent detection laser beams at fixed time intervals. The same line type in the figure indicates that 8 detection laser beam scanning lines output by the emission module of the LiDAR at a time form a scanning group, and 4 line types indicate that the emission module 10 outputs four groups (A, B, C and D) of detection laser beams in sequence. The first scanning apparatus 21 (an apparatus for scanning in the vertical direction) scans in the vertical direction in a fixed scanning mode (that is, a fixed scanning speed and a fixed scanning step size). The number of scanning lines in each scanning group is 8, and an angle interval between the scanning lines is δθ. At a moment t1, the scanning group A outputs a group A of 8 detection laser beam scanning lines at fixed frequency to scan from top to bottom, and the scanning module continues to scan downwards at a fixed step size of 8×δθ. At a moment t2 when the scanning module completes the fixed step size of 8×δθ, the scanning group B outputs a group B of 8 detection laser beam scanning lines at fixed frequency to continue scanning from top to bottom. At a moment t3 when the scanning module completes the fixed step size of 8×δθ, the scanning group C outputs a group C of 8 detection laser beam scanning lines at fixed frequency to continue scanning from top to bottom until the entire spatial region is scanned, and a scanning line with resolution of δθ is formed in the entire space. Either time delay of the scanning module from the moment t1 to the moment t2 of completing the fixed step size of 8×δθ or time delay of the scanning module from the moment t2 to the moment t3 of completing the fixed step size of 8×δθ is fixed time delay T. When the emission module 10 uses a fixed time interval and the scanning apparatus scans in a fixed scanning mode, a scanning field of view with uniform scanning density can be formed. The four groups (A, B, C and D) of detection laser beams can be detection laser beams formed after four scans of the same emission group. In some embodiments, the four groups (A, B, C and D) of detection laser beams can be detection laser beams formed after scanning and emissions of different emission groups at different times.

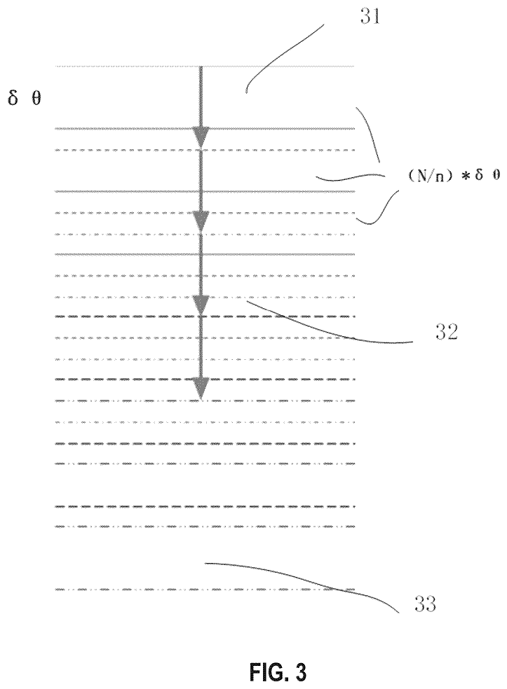

In an embodiment, as shown in FIG. 3, the LiDAR can also form a scanning field of view with nonuniform scanning densities based on a requirement, for example, a detection field of view with dense scanning lines in the middle and sparse scanning lines on two sides. The scan density is an overlapping degree of scanning lines of scanning groups in the scanning region. For example, a preset subregion 31 is formed by overlapping some scanning lines of the scanning group A and the scanning group B and the preset subregion 33 is formed by overlapping some scanning lines of the scanning group C and the scanning group D. The scanning lines in the preset subregion 31 and the preset subregion 33 are relatively sparse and are at a low scanning density. The preset subregion 62 is an overlapped region of the scanning groups A, B, C and D, and scanning lines in the preset subregion 32 are relatively dense and are at a high scanning density. This indicates that the preset subregion 62 is the region of interest, and the preset subregion 31 and the preset subregion 33 are secondary regions of interest.

In an embodiment, when the emission block has one emission group, an emission time interval corresponding to different emissions of the same emission group can be controlled to control a distribution density of the scanning lines. In an embodiment, the emission module includes multiple emission groups, the emission time interval between different emission groups can also be controlled to control the distribution density of the scanning lines. In an embodiment, an interval between the scanning lines corresponding to the two emissions can also be implemented by controlling a magnitude of a scanning step size of the scanning apparatus in one dimension.

In an embodiment, the scanning mode may be scanning a preset subregion at an intergroup interval between the scanning groups corresponding to the preset subregion, and a formula for calculating the intergroup interval between the scanning groups is:

$$δβ = \frac{N}{n} δθ ;$$

where δβ is the inter-group interval;
δθ is an angle interval between scanning lines in the scanning group;
N is the number of scanning lines in each scanning group, and N is an integer; and
n is a densification multiple of the scanning line corresponding to the preset sub-region, n is an integer and n≥0.

In an embodiment, when an interval between scanning groups is controlled via a step size of the scanning apparatus in one dimension, the step size of the scanning apparatus is equal to the intergroup interval δβ. An angular interval between first scanning lines corresponding to different emissions of the emission group in the first direction is controlled to be equal to the intergroup interval δβ.

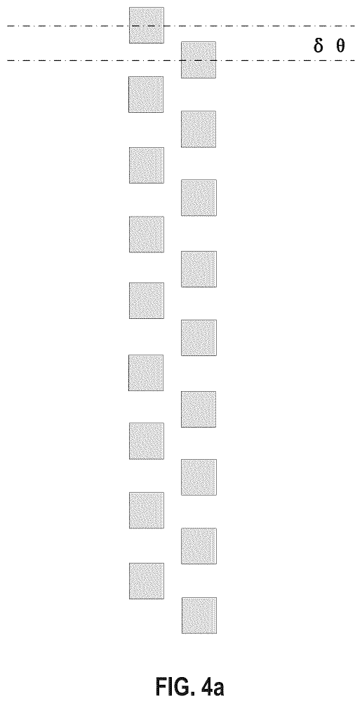

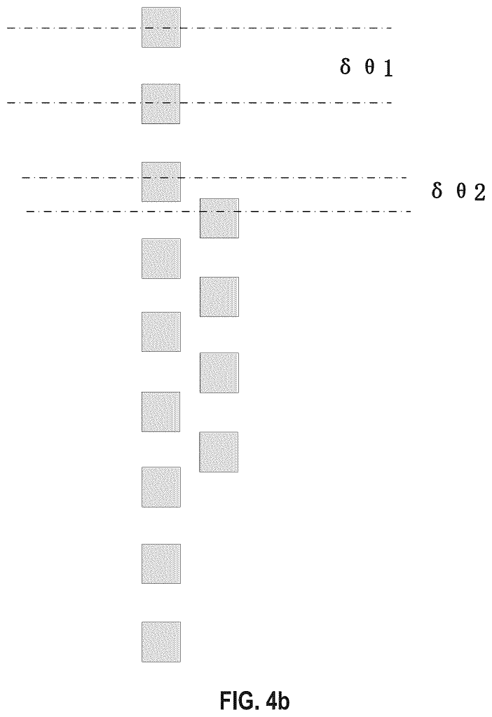

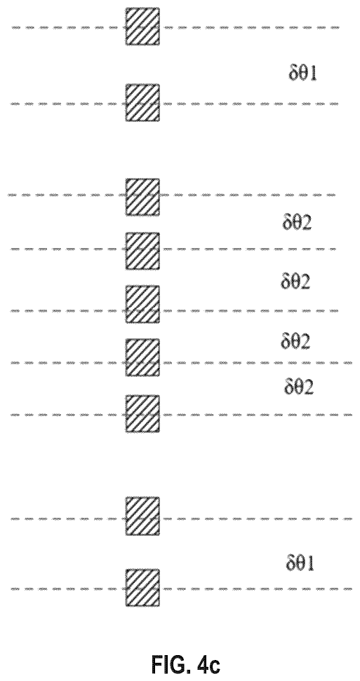

In an embodiment, the angle interval δθ between the scanning lines in the scanning line group can be implemented by setting an arrangement interval between emission devices or by controlling emitting lasers to perform emission at intervals in some or all of the regions. Same emission group may be arranged in one column or different columns. In an embodiment, when the same emission group is arranged in two columns, as shown in FIG. 4a, the angle interval δθ can be reduced by arranging all the emission devices in the same emission group in a staggered manner; or, as shown in FIG. 4b, the angle interval δθ of a target region is reduced by arranging emission devices in a staggered manner in a partial region. The point cloud density in the target region can be further improved while a setting of the scanning apparatus remains unchanged. In an embodiment, the emission devices in the same emission group are arranged in a column, the interval between the emission devices at the edge and the interval between the emission devices in the central region can also be set to be different, so that a point cloud in the target region is denser. In an embodiment, as shown in FIG. 4c, an interval between edge emission devices in the same emission group is δθ1, and an interval between central emission devices is δθ2, where δθ1≥δθ2.

In an embodiment, the multiple scanning lines are reflected by an obstacle to be received by the receiving module 30. Based on information about the echo beam received by the receiving module 30, distance information, emissivity information and the like of the target object in the detection region can be determined.

In an embodiment, an interval between the emission channels of two adjacent emission devices in the same group of emission devices is greater than a preset interval, and the preset interval can be 2 to 3 times a divergence angle of laser beams, so that light spots formed by the laser beams emitted by the two adjacent emission devices do not overlap on retinas of human eyes, thereby ensuring safety of the human eyes.

In an embodiment, the time interval between laser beams emitted during two adjacent emissions of the emission module is longer than preset duration, so that total energy of the laser beam entering the human eyes within specific duration is relatively small, thereby ensuring the safety of the human eyes.

In an embodiment, as shown in FIG. 1, the first scanning apparatus 21 is a galvanometer, the second scanning apparatus 22 is a rotating mirror, the rotating mirror is a regular quad prism, and the first mirror and the second mirror are adjacent. The galvanometer reciprocates around the x-axis, so that the laser beam scans along a vertical direction. The rotating mirror rotates around the y-axis, so that the laser beam scans along a horizontal direction. In an embodiment, an emission end scans by using the galvanometer and the rotating mirror, the emission end and the receiving end share the rotating mirror, and the receiving end scans by using only the rotating mirror, so that an aperture of the receiving end is not limited by a reflection surface of the first scanning apparatus (that is, a size of the galvanometer), which can reduce the size of the galvanometer, thereby improving control flexibility of the galvanometer.

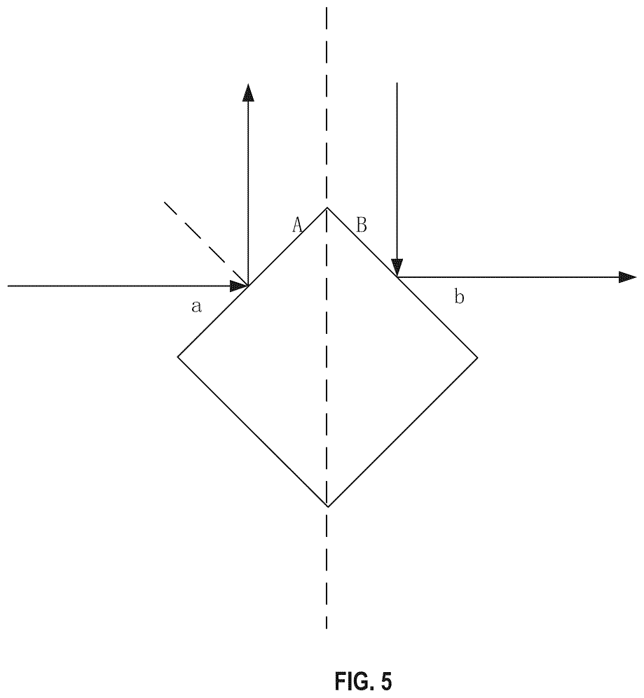

In an embodiment, as shown in FIG. 5, an included angle between the first mirror A and the second mirror B is twice a first angle a and twice a second angle b. The first angle a is an included angle between a laser beam emitted to the first mirror A and the first mirror A, and the second angle b is an included angle between an echo beam emitted from the second mirror B and the second mirror B. The emission module and the receiving module are arranged based on the foregoing angular relationship, so that the emission and receiving optical paths can be separated and the emission optical path and the receiving optical path do not interfere with each other, thereby improving detection accuracy of the LiDAR. Based on a position relationship between the emission module 10, the galvanometer and the rotating mirror, an emission angle of emitting the laser beams by the emission module 10 in a case of satisfying the first angle a can be determined, and a receiving angle of the receiving module 30 in the case of satisfying the second angle b can be determined based on the position relationship between the receiving module 30 and the rotating mirror, so that the emission optical path and the receiving optical path are separated.

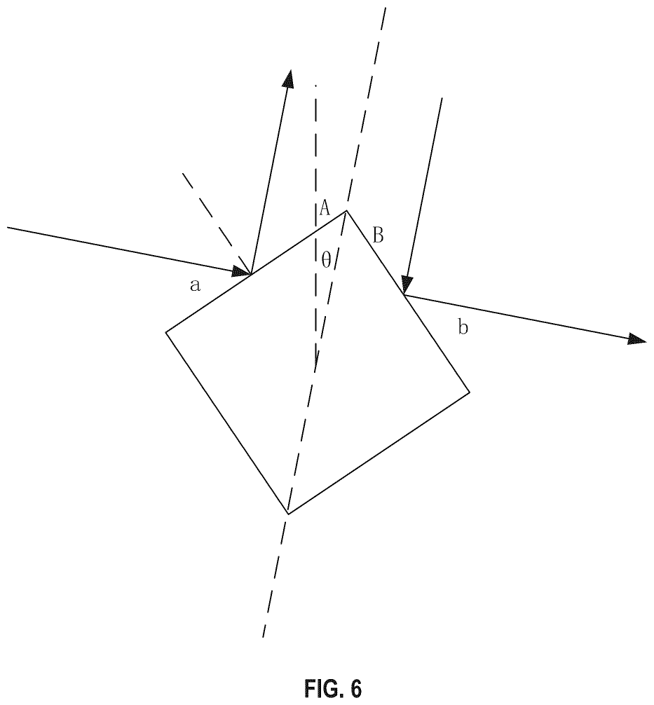

In an embodiment, as shown in FIG. 6, during rotation of the rotating mirror, a deflection direction of the laser beam (that is, the outgoing beam) emitted to the first mirror is the same as a deflection direction of the echo beam (that is, the echo beam) emitted from the second mirror. For example, assuming that a rotation angle of the rotating mirror is θ, it can be calculated based on a geometric relationship that a reduction in the angle between the outgoing beam and the first mirror is θ, and an increase in an angle between the corresponding echo beam and the second mirror is θ, so that the echo beam can be emitted to the receiving module, that is, the echo beam reflected by the rotating mirror can be effectively received by the receiving module during the rotation of the rotating mirror.

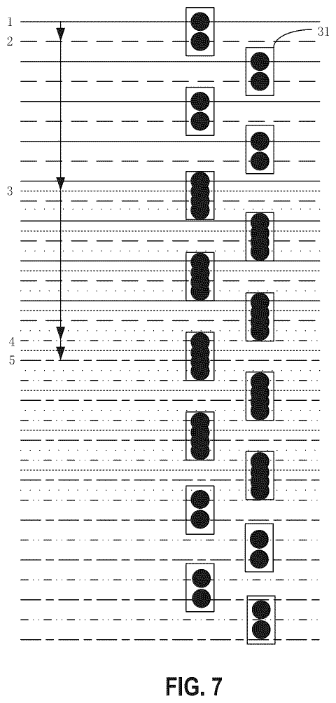

In an embodiment, as shown in FIG. 7, the first scanning apparatus 21 rotates along the first set direction, and the second scanning apparatus 22 rotates along the second set direction. After the laser beam passes through the first scanning apparatus 21 and the second scanning apparatus 22 in sequence, multiple scanning lines arranged along the first direction (that is, the vertical direction) are formed in the detection region. The receiving module 30 includes at least two receiving devices 31, and the receiving devices 31 may be photoelectric sensors.

The receiving device 31 may be, for example, an avalanche photo diode (APD) array or a silicon photomultiplier (SiPM) array. The type of the receiving device 31 is not limited in this application. At least two receiving devices 31 may be arranged into one or more columns. Angles of view of the two adjacent receiving devices 31 may be tangent or have partially overlapped regions, to avoid a situation where the echo beam cannot be received by the receiving device 31. The receiving devices 31 may have the same or different sizes. In an embodiment, each scanning line can correspond to one receiver 31. In an embodiment, the same receiver 31 can be reused for receiving some scanning lines. In an embodiment, as shown in FIG. 7, echo beams corresponding to at least two of the multiple scanning lines are received by the same receiving device 31. That is, the multiple scanning lines are divided into multiple groups, and the echo beams corresponding to each group of scanning lines are received by a receiving device 31. In this embodiment, not only the number of receiving devices and production costs of the LiDAR can be reduced, but also the resolution can be increased.

The interval between any two of the at least two scanning lines is less than the first preset angle. That is, an interval between any two of the scanning lines corresponding to the echo beams of the same receiving device 31 is less than the first preset angle. The first preset angle can be determined based on required detection resolution in the detection region. For example, the first preset angle is 0.5°, and therefore, not only receiving noise can be reduced, but also the number of receiving devices is reduced by making full use of the receiving devices.

In an embodiment, as shown in FIG. 7, in receiving devices at upper and lower ends, if the echo beam of a receiving device corresponds to two scanning lines, an interval between the two scanning lines is less than the first preset angle. In receiving devices in the middle, when the echo beam of a receiving device corresponds to four scanning lines, the maximum interval between the two scanning lines is less than the first preset angle, so that the interval between any two of the four scanning lines is less than the first preset angle.

In an embodiment, at least two receiving devices are arranged into multiple columns, and receiving devices in two adjacent columns are staggered, so that main optical axes for receiving echo beams by any adjacent receiving devices are staggered from each other, so that the distance between the two adjacent receiving devices can be reduced in a case that a manufacture process of the receiving devices is limited. For example, as shown in FIG. 7, multiple receiving devices are arranged into two columns, and the two columns of receiving devices are staggered.

In an embodiment, in an edge region of the detection region, echo beams corresponding to the first number of scanning lines are received by the same receiving device (for example, receiving devices at two ends), and in a central region of the detection region, echo beams corresponding to the second number of scanning lines are received by the same receiving device (for example, a receiving device in the middle). The second number is greater than the first number. That is, scanning lines are sparse in the edge region, the interval between two adjacent scanning lines is large, and a few scanning lines share one receiving device. Scanning lines are denser in a central region, and the interval between two adjacent scanning lines is small. Many scanning lines share one receiving device, thereby achieving higher resolution in the central region. When the density of the scanning lines is increased based on a requirement of a detection scenario to increase the resolution, the detection region can be detected without increasing the number of receiving devices. In addition, crosstalk between the scanning lines can be reduced by reducing the distance between multiple scanning lines corresponding to the same group of emission devices, thereby improving an anti-interference capability. Rotational speeds of the first scanning apparatus and the second scanning apparatus in the central region can be reduced, or an angular interval between two adjacent emission channels in the central region is reduced, to increase the density of the scanning lines in the central region.

In an embodiment, a receiving divergence angle of each receiving device is less than a second preset angle. For example, the second preset angle can be 0.5°, thereby reducing the receiving noise and improving the ranging capability. An optical adjustment module can be disposed to adjust the distance between the detection region and the receiving module 30 or an angle between the echo beam and the receiving module 30, to adjust the receiving divergence angle of each receiving device. The optical adjustment module can be one or more lens optics devices. The number of lens, the type of the lens, and the distance between adjacent lenses can all be configured according to actual needs and are not limited herein.

In an embodiment, the scanning lines emitted simultaneously in the multiple scanning lines are received by different receiving devices, which can reduce interference between the scanning lines. For example, as shown in FIG. 4, the emission module is configured to include 8 emission devices corresponding to 8 emission channels and 8 receiving channels, and a channel interval between the two adjacent emission channels is 0.4°. During rotation of the first scanning apparatus and the second scanning apparatus, the scanning lines formed by the laser beams scan in the horizontal and vertical directions respectively. The first scanning apparatus forms a group of scans after each rotation, and each group of scans correspond to 8 scanning lines. Five groups of scans are set from top to bottom in the detection region (one line type corresponds to one group of scanning lines in FIG. 4). A total of 40 scanning lines are formed, and the 40 scanning lines can form 6.2° detection space. Based on the set first preset angle and second preset angle, the echo beams corresponding to the 40 scanning lines are received by 16 receiving devices. The scanning lines emitted simultaneously are received by different receiving devices. Because one receiving device can receive echo beams corresponding to multiple scanning lines, the scanning lines corresponding to the echo beams of the same receiving device scan the detection region at different moments. That is, the scanning lines corresponding to the echo beams received by the same receiving device are scanning lines formed by the first scanning apparatus at different positions. For example, in receiving devices at two ends, two scanning lines corresponding to echo beams of one receiving device are formed by the laser beams emitted at two moments respectively. In the receiving device in the middle, four scanning lines corresponding to the echo beams of one receiving device are formed by laser beams emitted at four moments respectively, which can improve the resolution without increasing the number of receiving devices.

In another embodiment, more scanning lines can be added in the central region in an interpolation method. With the scanning lines added, the receiving devices in the middle can be still used without increasing the number of receiving devices, so that the resolution of the LiDAR can be further improved without increasing the number of receiving devices.

In an embodiment, positions of the scanning lines at each moment can be determined based on positions of the emission module and the beam adjustment module, and positions of the echo beams corresponding to the scanning lines are further determined. The number of receiving devices and the size and position of each receiving device can be determined based on the positions of the echo beams, and therefore, not only the receiving noise is reduced, but also the number of receiving devices is reduced.

Each receiving device can always be working during a target detection process. Each receiving device can also be turned on when there is an echo beam at the position of the receiving device, and can also be turned off when there is no echo beam at the position of the receiving device, thereby reducing energy consumption of the receiving device.

As shown in FIG. 1, in an embodiment, the beam adjustment module 20 also includes a plane mirror 23. An echo beam is reflected by a second mirror of the second scanning apparatus 22 and then directed to the plane mirror 23. An echo beam reflected by the plane mirror 23 is received by the receiving module 30, so that a direction of the optical path can be changed and the size of the LiDAR can be reduced.

In an embodiment, the beam adjustment module 20 further includes an emission shaping device and a receiving shaping device, and both the emission shaping device and the receiving shaping device are shaping lenses. The emission shaping device is configured to shape the laser beam and emit the shaped laser beam to the first scanning apparatus 21, so that the energy of the laser beam emitted to the detection region can be evenly distributed, thereby improving the detection accuracy. The receiving shaping device is configured to shape the echo beam, and to emit the shaped echo beam to the receiving module 30, so that energy of the echo beam emitted to the receiving module 30 can be evenly distributed, thereby improving the detection accuracy. In another possible embodiment, the beam adjustment module 20 may alternatively include only the emission shaping device, or the beam adjustment module 20 may alternatively include only the receiving shaping device.

What is claimed is:

1. A LIDAR, comprising: an emission module, a beam adjustment module, and a receiving module, wherein the beam adjustment module comprises a first scanning apparatus and a second scanning apparatus, and the second scanning apparatus comprises a first mirror and a second mirror, wherein:
the emission module comprises at least one emission device, the emission device is configured to emit a laser beam, the laser beam is sequentially reflected by the first scanning apparatus and the first mirror of the second scanning apparatus and then directed toward a detection region, the first scanning apparatus is rotated in a first set direction to drive the laser beam to scan along a first direction, and the second scanning apparatus is rotated in a second set direction to drive the laser beam to scan along a second direction; and
an echo beam is formed after the laser beam is reflected in the detection region, the echo beam is reflected by the second mirror of the second scanning apparatus and then received by the receiving module, and the receiving module comprises at least two receiving devices arranged into an array.

2. The LiDAR according to claim 1, wherein the laser beam forms multiple scanning lines arranged along the first direction in the detection region, receiving beams corresponding to at least two of the multiple scanning lines are received by the same receiving device, and scanning lines emitted simultaneously in the multiple scanning lines are received by different receiving devices.

3. The LiDAR according to claim 2, wherein at least two receiving devices are arranged into multiple columns, and receiving devices in two adjacent columns are staggered, so that main optical axes for receiving echo beams by any adjacent receiving devices are staggered from each other.

4. The LiDAR according to claim 2, wherein in an edge region of the detection region, echo beams corresponding to a first number of the scanning lines are received by the same receiving device, and in a central region of the detection region, echo beams corresponding to a second number of the scanning lines are received by the same receiving device, and the second number is greater than the first number.

5. The LiDAR according to claim 1, wherein the first mirror and the second mirror are adjacent, an included angle between the first mirror and the second mirror is twice a first angle and twice a second angle, the first angle is an included angle between an emission laser beam emitted to the first mirror and the first mirror, and the second angle is an included angle between an echo beam emitted from the second mirror and the second mirror.

6. The LiDAR according to claim 1, wherein the first scanning apparatus is a galvanometer and the second scanning apparatus is a rotating mirror.

7. The LiDAR according to claim 1, wherein the emission module comprises multiple emission devices, the multiple emission devices are divided into multiple groups, the same group of emission devices simultaneously emit laser beams, and different groups of emission devices emit laser beams at preset time intervals.

8. The LiDAR according to claim 7, wherein spacing between emission channels of two adjacent emission devices in the same group of the emission devices is greater than preset spacing.

9. The LiDAR according to claim 1, wherein a diameter of a light spot formed by the laser beam within a first preset distance is greater than a preset length.

10. The LiDAR according to claim 1, wherein a time interval between two adjacent emissions of laser beams performed by the emission module is greater than preset duration.
